(19) United States
(12) Patent Application Publication
(10) Pub. No.: US 2010/0095365 A1
(43) Pub. Date: Apr. 15, 2010

(54) Self-setting security system and method for guarding against unauthorized access to data and preventing malicious attacks

(76) Inventors: Wei-Chiang Hsu, Taichung (TW); Yu-Cheng Hsu, Yilan (TW); Peng-Yu Huang, Taipei (TW); Tsung-Lin Yu, Taipei (TW); Chang-Wei Chung, Changhua (TW); Hen-Jui Liang, Taipei (TW); Hui-Chen Cheng, Taipei (TW)

Correspondence Address: CLARK & BRODY, 1090 VERMONT AVENUE, NW, SUITE 250, WASHINGTON, DC, 20005, US

(21) Appl. No.: 12/285,731

(22) Filed: Oct. 14, 2008

(51) Int. Cl. G06F 17/00

(52) U.S. Cl. 726/11

(57) ABSTRACT

A self-setting security guarding system and method for protecting against unauthorized access to data stored in a data processing apparatus, comprising setting various items used to guard data, wherein the items consist of protected areas with access control for data storage and access therein, authorized types of files with access controls, and access rules of safety regulations enabling the data processing apparatus to verify access to data contents stored therein or in the protected area thereof; and detecting access events of the protected area or types of files using the access control and generating a request for analysis when an access event is detected, and further analyzing whether the detected access event complies with the access rules and the analysis request to permit or deny execution of said access event depending on whether it complies or not with safety regulations.

### BACKGROUND OF THE INVENTION

1. Field of the Invention

The present invention generally relates to security guarding systems and methods for protecting against unauthorized access to data, and, more particularly, to a security guarding system and method that allow users to set the protected storage area, types of data files and security operations of accessing data within the computer/network system to thereby protect against attacks and acheive effective self-management and optimal protection.

2. Description of the Related Art

Adequate network security is now accepted as a basic requirement for every e-commerce or networked system. This applies to all the underlying components: the LAN, Firewall, Routers, Internet, and so on. Protection systems exist but issues remain to be solved in ensuring that security is both appropriate and sufficient, that there are no major security holes, and that the system can be audited methodically.

To assist with all these issues, a common approach is to employ firewall technology to effectively guard against malicious behavior from a remote hacker or attacker into an internal network of an enterprise or a local area network. For an intranet, a firewall is either a dedicated appliance or software running on a computer, which inspects network traffic passing through it, and denies or permits passage based on a set of rules. A firewall's basic task is to regulate the flow of traffic between computer networks of different trust levels. Typical examples are the Internet which is a zone with no trust and an internal network which is a zone of higher trust. A zone with an intermediate trust level, situated between the Internet and a trusted internal network, is often referred to as a “perimeter network” or demilitarized zone (DMZ).

For instance, a gate firewall is configured in the network depicted in FIG. 1. Naturally, the depiction of the firewall here is representative and is not limited to the network configuration shown but can vary according to security requirements. The DMZ 13 with an intermediate trust level is a computer host configured between (trust-wise) an internal network 10 of an enterprise and the Internet 11, thereby protecting data of internal servers within the internal internet against unauthorized access by remote users to data stored therein. Typically, the DMZ 13 stores less confidential data and/or data that needs to be accessed from outside such as that stored in WWW, FTP or EMAIL servers and thus can be easily intruded due to its open nature, but since the DMZ 13 is substantially separate from the internal network 10, the internal network 10 remains unharmed even if the DMZ 13 is attacked.

However, the defense provided by the DMZ 13 (a kind of firewall) and the gate firewall 12 can restrict authorized communication to a port connecting from the Internet but the internal networked users connecting to the Internet are not constrained. As such, the internal network can be adversely exposed to malicious Trojan horse viruses through various network connection channels as internal network users connect to the outside Internet. To guard against such remote attackers and hackers, many enterprises choose to restrict internet connections with the defense of firewalls or networked devices. However, hackers and attackers continously develop more and more vicious means to intrude and attack networked systems by malicious connections, wherein they disguise themselves as having authorized connections, such as backdoor connections, thereby avoiding the blocking of multiple defenses of firewalls or scanning systems. For instance, communication port 80 is often used by a backdoor program to connect to a host, or a browser is installed to escape detection and blocking of firewalls or detecting systems.

In addition to the foregoing defense mechanisms, there is a variety of anti-virus software available that aim to provide adequate protection against malware including Trojan horses, worms, dialers, spyware and more. Some work by blocking both known and unknown malware threats before they can install and cause any harm to a computer, while others work by constantly monitoring malicious behavior involving browser hijackers, Trojan horse viruses and the like. However, so far, the existing protection means against malware have not been found to be completely satisfactory for effectively guarding against attacks from all sorts of diverse threats.

Therefore, there is a constant need for an effective protection mechanism that can solve the problems facing the internal network systems as well as private end users.

### SUMMARY OF THE INVENTION

In view of the inadequate security mentioned above, a primary objective of the invention is to provide an effective guarding system and method capable of defending and protecting an internal networked system against attacks from internal users with machines that have been compromised despite the protection of a firewall, assuring security of the internal network for such normally trusted users.

Another primary objective of the invention is to provide a guarding system and method capable of providing users with an access verification mechanism, assuring security in the process of data access thereto, thereby achieving an optimal defending effect against virus attacks and unauthorized access to data contents.

To achieve the above and other objectives, the present invention proposes a self-setting guarding system and method for protecting and managing data stored in the data processing apparatus. The self-setting guarding system is composed of an area-setting unit for setting and storing the protected areas with authorized access control in the data processing apparatus; a type-setting unit for setting the type of data files having the access control thereto; a rule-setting unit for setting and storing access rules providing required safety regulations to the data processing apparatus for accessing data thereto or the protected area; a detecting module for detecting data access events that occurred in the protected area set by the area-setting unit having the access control or the type of data files set by the type-setting unit having the access control, and further generating a request for analysis when an access event is detected; and an analyzing module for analyzing whether the detected access event complies with safety regulations based on access rules obtained from the rule-setting unit according to the analysis request, thereby allowing or denying said access event to be executed depending on whether it complies or not with the safety regulations.

The self-setting guarding method for protecting and managing data contents stored in the data processing apparatus comprises the steps of: setting and storing items of data to be guarded, wherein the guarded items comprise the protected area with authorized access control for controlling storage and access of data therein, authorized types of files with access controls for storing and accessing data thereto, and access rules of safety regulations enabling the data processing apparatus to verify access to data contents stored therein or in the protected area thereof; detecting data access events of the protected area or authorized types of data files having the access control and generating a request for analysis when an access event is detected; analyzing whether the detected access event complies with safety regulations based on access rules and the analysis request for allowing or disallowing said access event to be executed depending on whether said event complies or not with safety regulations.

In contrast to the conventional network protection technologies, the self-setting guarding system and method of the present invention is characterized by detecting occurrences of I/O access events at a user end and analyzing whether the authorized storage protected area thereof has been randomly accessed to effectively block malicious behavior, thereby preventing remote intruders and hackers from causing harm to the networked systems by malicious virus infection.

### BRIEF DESCRIPTION OF THE DRAWINGS

The present invention can be more fully understood by reading the following detailed description of the preferred embodiments, with reference made to the accompanying drawings, wherein:

FIG. 1 is a diagrammatic illustration of the conventional network architecture with a firewall configuration;

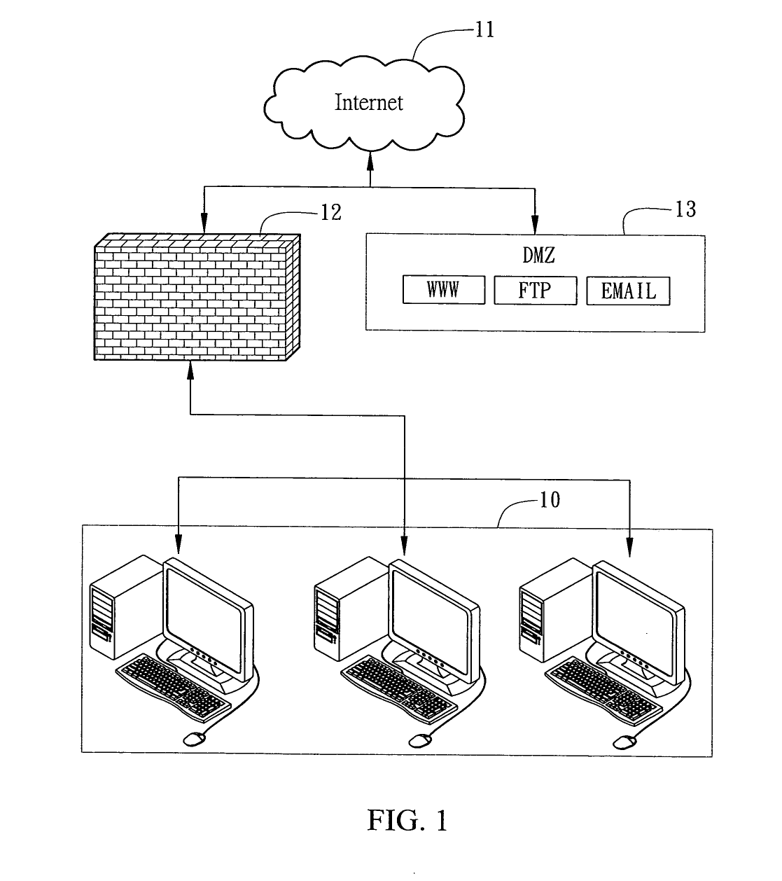

FIG. 2 is a block diagram showing the basic structure of the self-setting security guarding system being applied to the data processing apparatus in accordance with the present invention;

FIG. 3 is a block diagram showing the basic structure of the rule-setting unit of the self-setting guarding system in accordance with the present invention; and

FIG. 4 is a flowchart showing the steps of carrying out the self-setting guarding method in accordance with the present invention.

### DETAILED DESCRIPTION OF THE PREFERRED EMBODIMENTS

The following illustrative embodiments are provided to illustrate the disclosure of the present invention; these and other advantages and effects can be readily understood by persons skilled in the art after reading the disclosure of this specification. This invention concerns data protection techniques used in systems that perform verification operations for purposes of permitting or denying access to data contents. The present invention can also be performed or applied by other differing embodiments. The details of the specification may be changed on the basis of different points and applications, and numerous modifications and variations can be devised without departing from the spirit of the present invention.

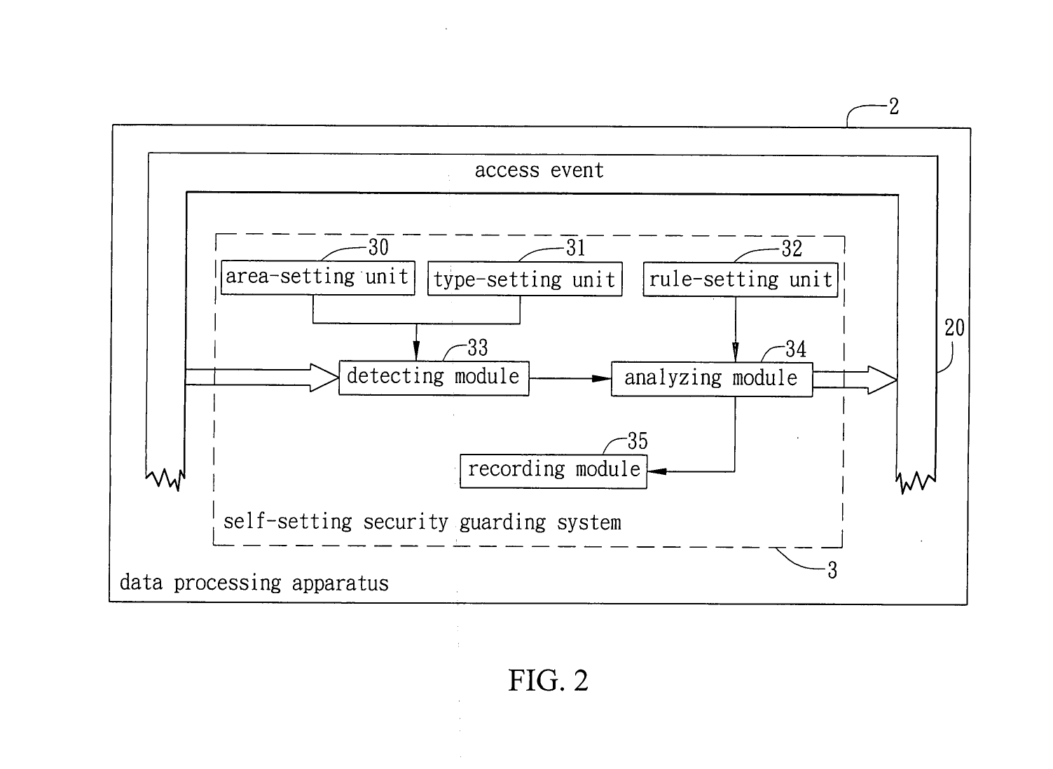

FIG. 2 is a block diagram showing the self-setting guarding system 3 applied to a data processing apparatus 2 in accordance with the present invention. In a preferred embodiment, the data processing apparatus 2 may be, but is not limited to, an electronic device such as a desktop computer or a NB computer, and the safety guarding system 3 of the invention is adapted to detect and analyze whether an access event 20 in the data processing apparatus 2 complies with the safety regulations, wherein the access event 20 includes access to the memory, the disc drive and a network communication port thereof, and execution of said access event will be permitted or denied depending on whether the event 20 complies or not with the preset safety regulations, thereby effectively defending attacks from a remote attacker or hacker and ensuring security in a local area network against both data exposure and virus infection.

The self-setting security guarding system 3 is composed of an area-setting unit 30, a type-setting unit 31, a rule-setting unit 32, a detecting module 33, an analyzing module 34, and a recording module 35. The area-setting unit 30 sets the access control to the storage areas of the data processing apparatus 2, classifying and storing authorized storage areas as the protected areas for protection and detection of access events. More specifically, the data processing apparatus 2 stores data in storage areas including the hard disk, memory or a DMZ in a local network and the like, wherein a hard disk in a storage area and the DMZ in a local network may be set and defined as general or common protected areas or highly sensitive protected zones depending on the preset request levels of protection, such as peer-to-peer (P2P) shared software and the operating system of the data processing apparatus 2.

Further, the protected area may be divided into and defined as a restricted area, an external area and a common area according to the request level of protection. For instance, a restricted area is defined as the storage area of the operating system of the data processing apparatus 2, wherein the restricted area denies events of data access (actions of storing, reading and opening a data file, and so on) therein. In other words, the restricted area has the highest level of protection to prevent remote attackers and hackers from accessing data thereof and causing harm to the network system. The external storage area permits execution of events of data access therein, such as data contents stored in the DMZ as well as data allowing P2P shared software to download. That is, the external storage area has a lower request level of protection. Note that permission or prohibition of access events within said areas depends on the types of data contents set by the type-setting unit 31 that is described shortly.

The type-setting unit 31 sets and stores the type of files with authorized access control to allow the subsequent detection and analysis of said access events 20 in the data processing apparatus 2, thereby determining whether or not the access events 20 comply with access safety regulations. Further, the type-setting unit 31 is defined into a white-list block and a black-list block according to the levels of access control, wherein the white-list block stores authorized events of data access, for example, data content edited by various programs such as word-processing, spreadsheet, and database programs, whereas the black-list block stores types of data that are unauthorized and prohibited to access, such as rogue executable files being ran from an Internet browser or instant messenger communication software and the like.

The rule-setting unit 32 sets and then stores safety regulations for guarding events of data access of the data processing apparatus 2, wherein safety regulations include access rules controlling access to data stored in the protected area, the rules controlling access to data of downloaded files stored in the protected area, and the rules controlling access to data read by the data processing apparatus and connecting to a communication port thereof. For instance, the access rules controlling data access in the protected area do not permit access thereto if the data is stored in the restricted area, or said access rule prohibits data being accessed by a communication port if the data is stored in a common area of the protected area; and the rules controlling access to data contents of downloaded files prohibit generation of unknown executable files or access to downloaded data contents stored in the protected area.

The detecting module 33 detects occurrences of access events in the protected area or types of files having the access control, and generates a request for analysis when an event of data access thereto is detected. More specifically, when an event of data access 20 is received by the detecting module 33, it determines whether said access event 20 should be detected according to the protected areas set by the area-setting unit 30 and the type of data files set by the type-setting unit 31, thereby analyzing if said access event 20 may cause harm to the data processing apparatus 2 or jeopardize security of the local area network system.

The analyzing module 34 retrieves access rules from the rule-setting unit 32 to analyze the compliance of said access events 20 according to the request for analysis, wherein execution of data access is allowed or denied depending on whether said access event 20 complies or does not comply with the access rules, thereby eliminating malicious programs and behavior from intruding, manipulating and causing harm to the network system, particularly in the process of using popular shared software, such as instant messaging software or P2P software and the like.

The recording module 35 stores access events that fail to comply with the access rules after being analyzed by the analyzing module 34, wherein the recorded contents comprise names of files that do not comply with the access rule for later analysis.

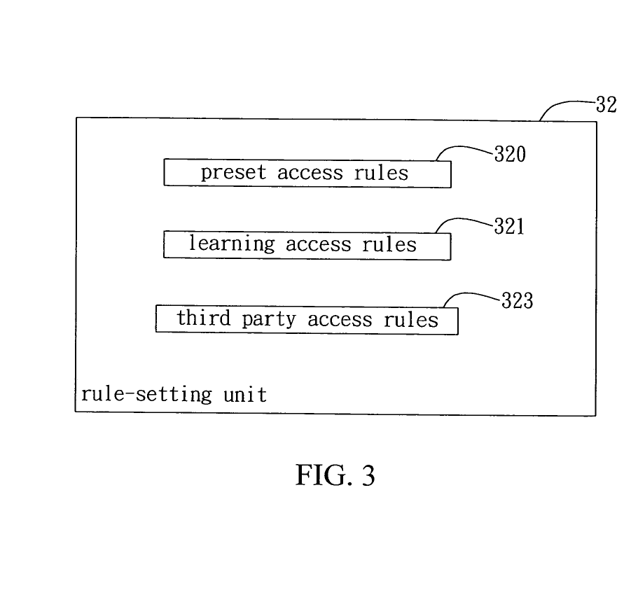

FIG. 3 is a block diagram showing another embodiment of the rule-setting unit 32 of the self-setting guarding system in accordance with the present invention. The rule-setting unit 32 comprises the preset access rules 320, the learning access rules 321 and third-party access rules 323, wherein the preset access rules relate to basic safety regulations pre-stored therein and include some of the safety regulations described above.

The learning access rules 321 provides measures for handling access to data as well as advanced safety regulations for controlling access events if it belongs to an authorized specific type of files set by the type-setting unit 31 or the protected area for data storage set by the area-setting unit 30. As a specific example, when data in the Word word-processing format is opened that is set to be a type of file with authorized access control, the learning access rules 321 proceeds to make a backup of the Word executable file (i.e. Word.exe) for protection, wherein the advanced safety regulations set by the learning access rules 321 are set to prevent data contents related to said Word.exe file from being replaced. In the event that an opened file containing a virus attempts to maliciously contaminate said Word executable File by replacing part of it, said backup file produced by the analyzing module 34 based on learning access rules 321 is used for data recovery purposes, thereby solving the drawback of not being able to recover the Word executable file upon being replaced or damaged by a virus. Additionally, a backup of said Word.exe file is also made according to the learning access rules 321 before said Word format file is analyzed by the analyzing module 34 in accordance with the preset access rules 320 to see if it complies with said safety regulation and may be allowed to open, wherein if said Word file is found to be not compliant with the safety regulations due to replacement of said Word executable file, the recording module 35 may record and transmit said Word file to related servers or providers of anti-virus software for reference, thereby developing a defending mechanism to prevent Word.exe files from being replaced.

Further, the advanced safety regulations stored in learning access rules 321 may include different security levels according to the degrees of sensitivity for defense and protection. For example, level 0 indicates that a questionable file that doesn't access data stored in the protected area and the data processing apparatus 2 is permitted to be accessed; level 1 indicates that specific data has been replaced and that files suspected of causing the replacement of said specific data should be isolated; and level 2 indicates the generation of unknown data that should be isolated and recorded, thereby secluding suspicious data and recording events of data access by the recording module 35 when suspicious data is found by the analyzing module 34 and unknown data is generated in the protected area set by the area-setting unit 30.

The third-party access rules 323 provide assistive safety regulations for governing specific types of data set by the type-setting unit 31 and the protected area set by the area-setting unit 30, wherein the assistive safety regulations are downloaded by servers of a networking system or from anti-virus software to supplement and enhance safety regulations stored in the preset access rules 320, wherein the assistive safety regulations provided by third-party access rules 323 are set according to anti-virus detecting mechanisms developed to guard against the latest viruses.

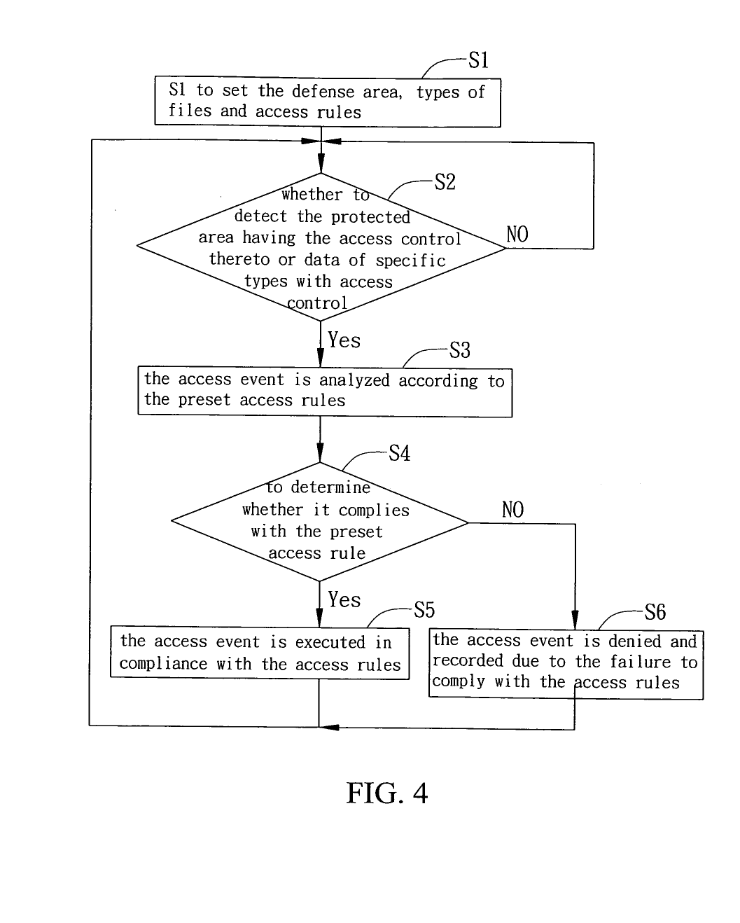

FIG. 4 is a flowchart showing the steps of carrying out the user-end safety guarding method in accordance with the present invention. As depicted herein, a first step S1 is executed to set the defense area for safety protection in the data processing apparatus 2, the types of files with authorized access control, and the access rules controlling access to data contents stored in the preset protected area and specific types of data, thereby setting the defense level required by the user-end. Then, the flow proceeds to step S2.

In step S2, a data access event 20 is detected to determine whether said event 20 is attempting to access data stored in the protected area having access control or data of a specific type with access control, and, if it is, the flow proceeds to step S3; whereas if not, flow returns back to step S2 for continued monitoring.

In step S3, the data access event 20 is analyzed according to the preset access rules, and then the flow proceeds to step S4.

In step S4, the data access event 20 is analyzed to determine whether it complies with the preset access rules, and if the event 20 does comply, flow proceeds to step S5, whereas if it does not comply, flow proceeds to step S6.

In step S5, the data access event 20 is executed in compliance with the access rules, and subsequently flow returns to step S2.

In step S6, the data access event 20 is denied because of failure to comply with the access rules, and this action is logged in a recording module, and then flow returns to step S2.

Specifically, the access event 20 is recorded for later analysis, and the recorded access events can be transmitted to the server to be read via the communication port of the data processing apparatus 2, wherein the sever may be configured, for example, by a service unit of an anti-virus software company for their reference, thereby developing preventative measures and effectively preventing malicious behavior from causing harm to the network system.

Compared to prior techniques, the self-setting guarding system and method of the present invention are characterized by defining and setting a defense storage area having access control, specific types of files to be protected and safety rules governing the access control, enabling the data processing apparatus to detect and analyze whether an access event is related to data stored in the protected area, thereby precluding malicious events and behavior of data access to maintain system reliability of network systems and the safety of data.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A self-setting security guarding system for providing data management and protecting against unauthorized access to data stored in a data processing apparatus, the system comprising:
an area-setting unit for setting and storing protected areas with authorized access controls in the data processing apparatus;
a type-setting unit for setting the types of data with access controls thereof;
a rule-setting unit for setting and storing access rules providing required safety regulations to the data processing apparatus for accessing data thereof or the protected area thereof;
a detecting module for detecting data access events that occur in the protected area set by the area-setting unit having the access control or the type of data contents set by the type-setting unit having the access control, and further generating a request for analysis when an access event is detected; and
an analyzing module for analyzing whether the detected data access events comply with safety regulations based on access rules obtained from the rule-setting unit according to the analysis request, thereby permitting or denying execution of said data access event when it complies or does not comply with the safety regulations.

2. The self-setting security guarding system as claimed in claim 1, wherein the protected areas include: a demilitarized zone (DMZ), the DMZ being configured between an internal network and an external public network; storage areas for storing data downloaded from peer-to-peer (P2P) shared software; one or more hard disks of the data processing apparatus or portions thereof; and the storage areas for the operating system of the apparatus, whether in RAM or on disk.

3. The self-setting security guarding system as claimed in claim 1, wherein the type-setting unit is defined into a white-list block and a black-list block in accordance with the level of access control, wherein the white-list block stores authorized events of data access thereof, whereas the black-list block stores types of data that are unauthorized and prohibited to access.

4. The self-setting security guarding system as claimed in claim 1, wherein the safety regulations include rules controlling access to data stored in the protected area, rules controlling access to downloaded data stored in the protected area, and rules controlling access to data read by the data processing apparatus and connecting to a communication port thereof.

5. The self-setting security guarding system as claimed in claim 1, wherein the rule-setting unit comprises preset access rules, learning access rules and third party access rules, wherein the preset access rules relate to basic safety regulations pre-stored therein; the learning access rules provide measures for handling access to data as well as advanced safety regulations for controlling data access if accessed data belongs to an authorized specific type of file or the protected area for data storage; and the third party access rules provide assisting safety regulations for governing specific types of data and the protected area, wherein the assisting safety regulations are downloaded by servers of networking systems or from anti-virus software to supplement the safety regulations.

6. The self-setting security guarding system as claimed in claim 1, further comprising a recording module for storing access events that fail to comply with the access rules.

7. A self-setting guarding method for providing data management and protecting against unauthorized access to data contents stored in a data processing apparatus, the method comprising the steps of:
setting and storing items of data to be guarded, wherein the guarded items comprise protected areas with authorized access control for controlling storage and access of data therein, authorized types of data contents with the access control for storing and accessing data thereto, and access rules of safety regulations enabling the data processing apparatus to verify access to data contents stored therein or in the protected area thereof, and
detecting events of data access to the protected area or authorized types of files with the access control and generating a request for analysis when an access event is detected, and further analyzing whether the detected access event complies with safety regulations based on the access rules and the analysis request to permit or deny execution of said access event depending on whether said event complies or does not comply with safety regulations.

8. The self-setting security guarding method as claimed in claim 7, wherein the protected area comprises a demilitarized zone (DMZ) configured between an internal network and an external public network, storage areas for storing data contents downloaded from peer-to-peer (P2P) shared software, one or more hard disks of the data processing apparatus and the storage area of the operating system of the apparatus, whether in RAM or on disk.

9. The self-setting security guarding method as claimed in claim 7, wherein the type of data files having the access control comprises types of files that are permitted data access as well as those that are denied data access.

10. The self-setting security guarding method as claimed in claim 7, wherein the safety regulations include rules controlling access to data stored in the protected area, rules controlling access to downloaded data contents stored in the protected area, and rules controlling access to data read by the data processing apparatus and connecting to a communication port thereof.

11. The self-setting security guarding method as claimed in claim 7, wherein the rule-setting unit comprises the preset access rules, learning access rules and third party access rules, wherein the preset access rules relate to basic safety regulations pre-stored therein; the learning access rules provide measures for handling access to data as well as advanced safety regulations for controlling data access if accessed data belongs to an authorized specific type of data or the protected area of data storage the third party access rules provide assisting safety regulations for governing specific types of data contents and the protected area, wherein the assisting safety regulations are downloaded by servers of networking systems or from anti-virus software to supplement the safety regulations.

12. The self-setting security guarding method as claimed in claim 7, further comprising storing access events that fail to comply with the access rules.
